(19) United States
(12) Patent Application Publication
(10) Pub. No.: US 2009/0172783 A1
(43) Pub. Date: Jul. 2, 2009

(54) Acquiring And Using Social Network Information

(76) Inventor: George Eberstadt, New York, NY (US)

Correspondence Address: FISH & RICHARDSON PC, P.O. BOX 1022, MINNEAPOLIS, MN, 55440-1022, US

(21) Appl. No.: 11/968,431

(22) Filed: Jan. 2, 2008

(51) Int. Cl. G06F 7/04

(52) U.S. Cl. 726/4

(57) ABSTRACT

Among other things, a user of a site is provided access to information about a person to whom the user has a connection. The connection is stored in a shared social network (SN) system controlled independently of the site. The information is displayed to the user of the site only in accordance with a permission of the person for whom the user has the connection.

### BACKGROUND

This description relates to acquiring and using social network (SN) information.

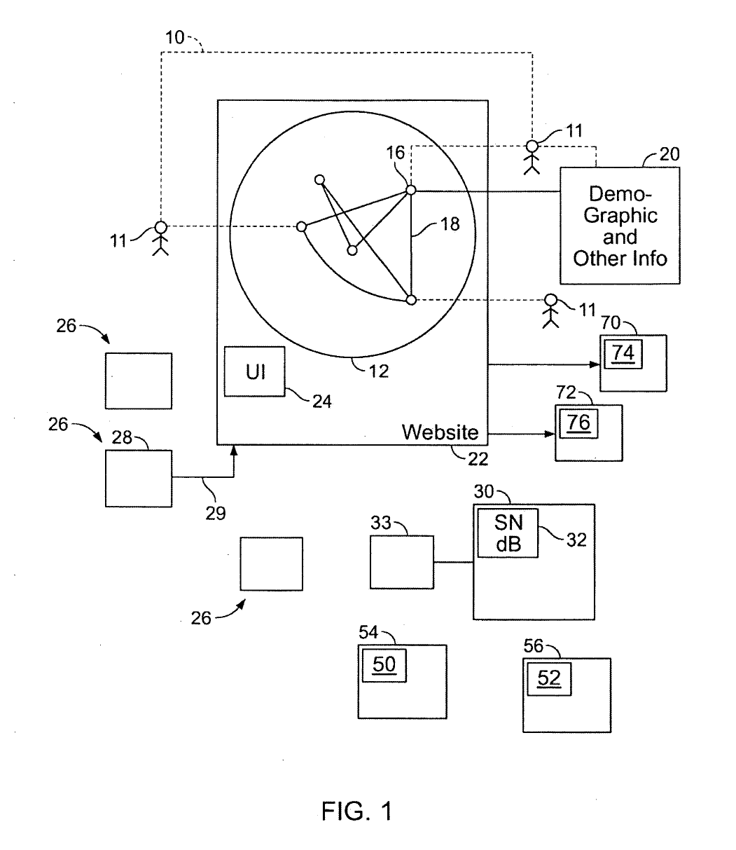

SN information includes, for example, information about connections between people and demographic and other information about the people who are the subject of the connections. As shown in FIG. 1, information about real life connections 10 among people 11 may be stored in a database 12 (also called a who-knows-whom database, a SN graph, or a SN database) in which each person 11 (and the demographic and other information 20 about the person) can be represented in a node 16 and the connections among people can be represented by connections 18 that join nodes.

SN databases such as database 12 are created and maintained as a core asset of SN sites 22, for example, Facebook or LinkedIn. The node information and the connection information of the database can be derived directly from the users of a SN site through a user interface 24 of the site (for example, when the user first registers or adds information later) or may be inferred from actions of users on the site, or may be obtained from other sources 26. For example, a separate site 28 that sells shoes may provide to the host of a SN site a list 29 of products purchased by people who are users of the SN site. The SN site may then, for example, display this information in association with other information about a “target” user, when an interested user of the SN site is viewing information about the target user. For example, if Bill is viewing Carol's profile on Facebook, he could be presented with a list of products that Carol has recently bought.

Although a site 30 may have a primary function other than maintaining a SN, such as retail sales, the site also may generate and maintain a proprietary SN database 32 about its customers 33. The proprietary SN database may include node information and connection information that is derived explicitly or implicitly from the customers as they register as users of the site, maintain their user profiles on the site, and use the site 30 for its main purpose. Such a site may use the proprietary SN database to enhance the experience of its users and improve the sales or other performance of the site.

Users who want to participate in the proprietary SN databases 50, 52 of multiple sites 54, 56 may register separately for each of them by providing demographic and personal information and defining connections they have with other people who are users of the site. To complete the creation of the connections for each of the proprietary SN databases, the other people whom they have identified are asked to verify and consent to the inclusion of the connection information in the database.

A SN site may make its SN database available to other parties 70, 72 who may develop applications 74, 76 to use the SN information. These applications are installed by the users on both sides of a connection defined by the SN database in order for the SN aspects of the applications to be usable.

### SUMMARY

In general, in an aspect, a user of a site is provided access to information about a person to whom the user has a connection. The connection is stored in a shared social network (SN) system controlled independently of the site. The information is displayed to the user of the site only in accordance with a permission of the person to whom the user has the connection.

Implementations may include one or more of the following features. The site is an affiliate of the shared SN system. The information about the person includes personal information. The information about the person is relevant to an activity being engaged in by the user of the site. The information about the person includes information about an activity of the person that is relevant to an activity being engaged in by the user of the site. The permission is stored in the shared SN system. Access to the information is provided by displaying the information. The site provides the information in connection with a feature or application of the site. The feature or application enables the user to engage in at least one of: a transaction, interaction with content (for example, by reading, listening, viewing, or submitting content) or a game. At least some of the information about the person is retrieved from storage in the site itself. At least some of the information about the person is retrieved from storage at the shared SN system.

In general, in an aspect, at a shared SN system, a permission is stored of a user to be applied at an independently controlled site to regulate access to information of the user stored on the site.

Implementations may include one or more of the following features. The permission is inferred automatically when the user registers on the shared SN system. The permission is associated with a specific person. The permission is associated with the site. The permission includes a trusted permission that enables the site always to give access to information of the user. The permission includes an “ask me first” permission that enables the site to give access to information of the user only after obtaining explicit permission of the user. The permission is associated with a characteristic of a connection between the user and another person. Thee connection information is organized in multiple networks based on characteristics of the users.

In general, in an aspect, a shared SN system includes information about a connection that a person has with a user of a site that is controlled independently of the shared SN system. The shared SN system also includes information about a permission given by the person to permit access by the user of the site to information about the person. The connection information and the permission information are made available to the site.

In general, in an aspect, at a shared SN system, SN connection information is maintained that has been entered by users through multiple sites that are controlled independently of the shared SN system and independently of one another.

Implementations may include one or more of the following features. The connection information for a user of the shared SN system includes a permission given by the user to permit one or more of the sites to allow access by a person who has a connection to the user, to information of the user. The SN connection information is shared with one or more of the sites under predetermined conditions.

In general, in an aspect, in conjunction with displaying information to a user of a site about an activity of the user, additional information is displayed that relates to the activity and is about a person with whom the user has a connection. The connection is stored in an independently controlled, shared SN system.

In general, in an aspect, a user, who has confirmed the existence of a connection with another person (the connection information having been stored in a shared SN system), regulates access to information about the user by the person to whom the user has confirmed the existence of the connection.

Implementations may include one or more of the following features. The access is regulated based on a category to which the other person-belongs. The access is regulated based on the identity of the other person. The access is regulated based on a feature of an activity of the other person on a site that is controlled independently of the shared SN system.

In general, in an aspect, a first user is provided access to information about another person who is also a user of the site and who has a connection to the first user. The connection is evidenced by information stored on a shared SN system. The access is given in accordance with a permission of the other person.

In general, in an aspect, at a shared SN system, connection information and permission information about a user are stored. At multiple sites that are controlled independently of the shared SN system, features and applications are provided based on the stored connection information and permission information and on information about the user stored at the sites.

In general, in an aspect, at a site, access by a user to information about another person with whom the user has a connection is regulated. The connection has been stored in an independently controlled, shared SN repository. The access is regulated based on a characteristic of the connection.

Implementations may include one or more of the following features. The characteristic includes the user of the site being a person of interest of the other person. The characteristic includes the user of the site having been invited to be a connection of the other person. The characteristic includes membership by the user and the other person in a group.

In general, in an aspect, at a shared SN system that is accessible from multiple other sites, SN connection information is automatically imported from an SN site that has connection information that is exposed to or can be gathered for use by third parties. The imported information is used to build an SN connection repository at the shared SN system.

In general, in an aspect, a user, who is engaged in an activity on a site, is advised that by registering with a shared SN system he may obtain information that is (a) related to the activity and (b) about people with whom he may have connections, and by a feature of the site. The user is then enabled to register with the shared SN system.

In general, in an aspect, SN information from a shared SN system is provided to an independently controlled site for use in a feature or application that serves users of the site. The shared SN system refrains from requiring any information to be returned by the site to the shared SN system.

In general, in an aspect, at a shared SN system, SN connection information is maintained about a user of the system. The connection information includes a permission given by the user. The permission enables one or more sites that are controlled independently of the shared SN system to allow access by a person who has a connection to the user, to information of the user that has been generated based on activities of the user on one or more of the sites.

In general, in an aspect, at one or more sites that are controlled independently of a shared SN system, access is allowed, by a person who has a connection to a user of the shared SN system, to information of the user that has been generated based on activities of the user on one or more of the sites. The access is allowed based on a permission that has been given by the user and has been recorded on the shared SN system.

In general, in an aspect, a user at a site is enabled to register connection information and permission information on a shared SN system that is controlled independently of the site. The user is then enabled to take advantage of the registered information in connection with using another site.

These and other aspects and features, and combinations of them, can be expressed as methods, apparatus, systems, means for performing functions, program products, and in other ways.

Among advantages of the invention are one or more of the following. Users can maintain their SN information in a single place yet enjoy features and applications that rely on this information at a large number of online facilities that are controlled independently of the repository where the SN information is stored. Users who would not bother to enter their SN information repeatedly at many individual online facilities may be encouraged to do so at the single shared repository.

Online facilities that wish to use SN information that may otherwise be hard to acquire can access a large volume of useful SN information from the shared repository. Each online facility can develop proprietary applications that use the SN information in ways that are well suited to their needs and the expectations of their users. The applications can take advantage of the fact that at least portions of the SN information can be stored on local repositories of the online facilities and be matched and combined with information about their own users. Online facilities can share (with authorization) confidential information among their users based on trusted relationships among the users. Online facilities can provide SN information within a local context without sharing the information with any other SN facility.

More interesting, effective, and useful experiences can be provided for users of online facilities, particularly with respect to transactions in which they are engaged because the display of transaction information to the users can be combined simultaneously with display of information from other people with whom the users have SN connections. The invention does not limit the viewing of the information about activities of others to a context that is centered on the identity of the other users or on the streams of activities in which the others are engaged. Complex and hierarchical designations of connections among users enable users to control access by others to their SN information based on selected characteristics or categories of relationships.

Other advantages and features will become apparent from the following description and from the claims.

### DESCRIPTION

FIGS. 1 through 3 are block diagrams.

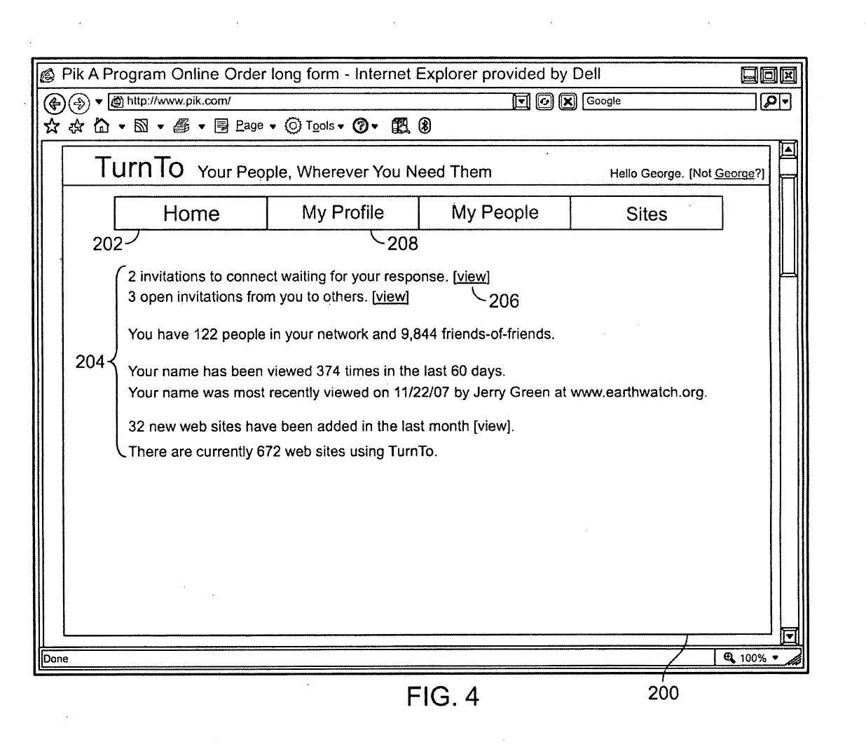

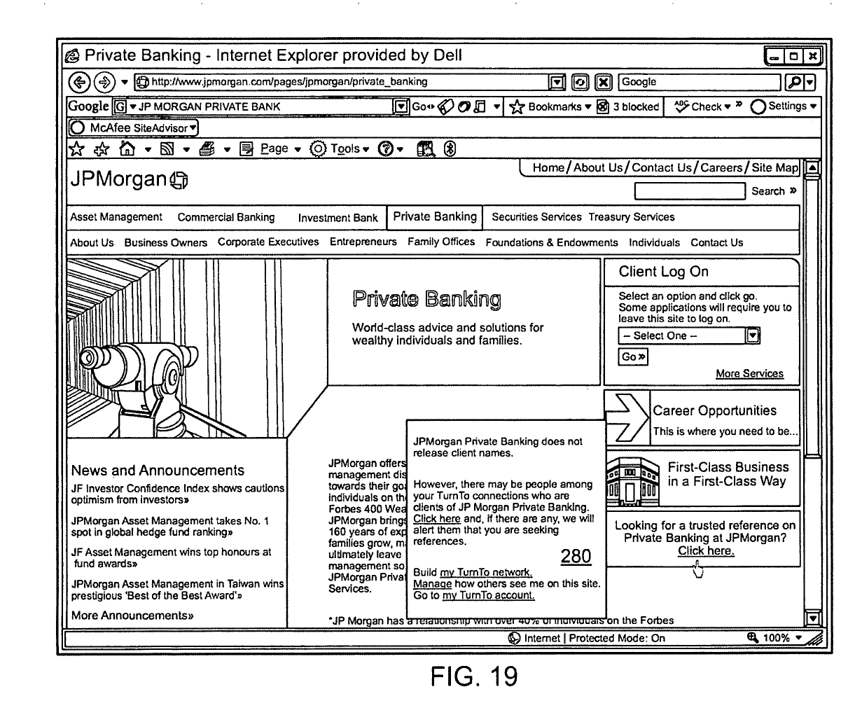

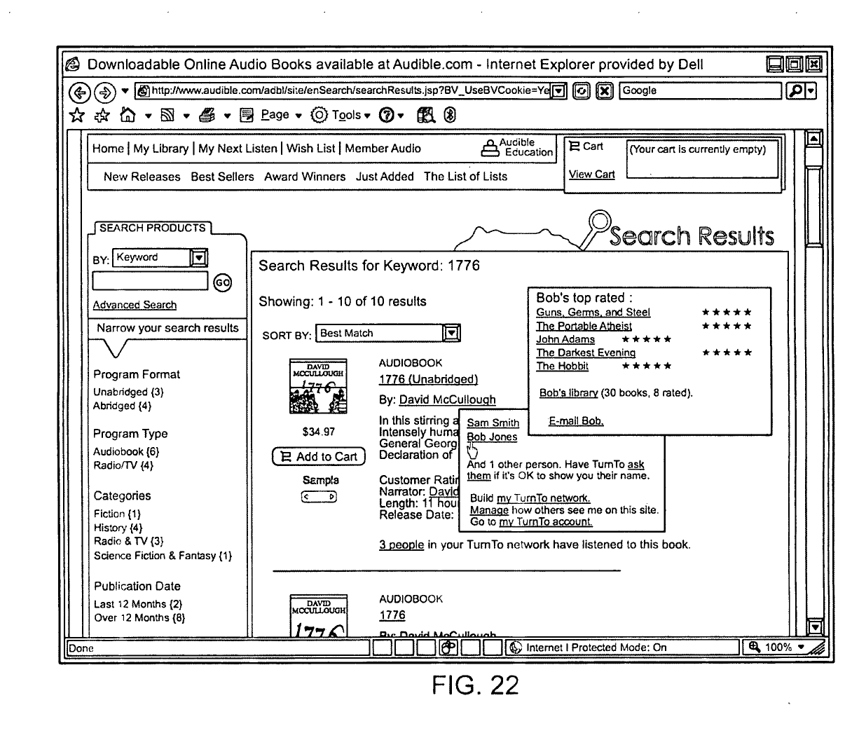

FIGS. 4 through 23 are screen shots.

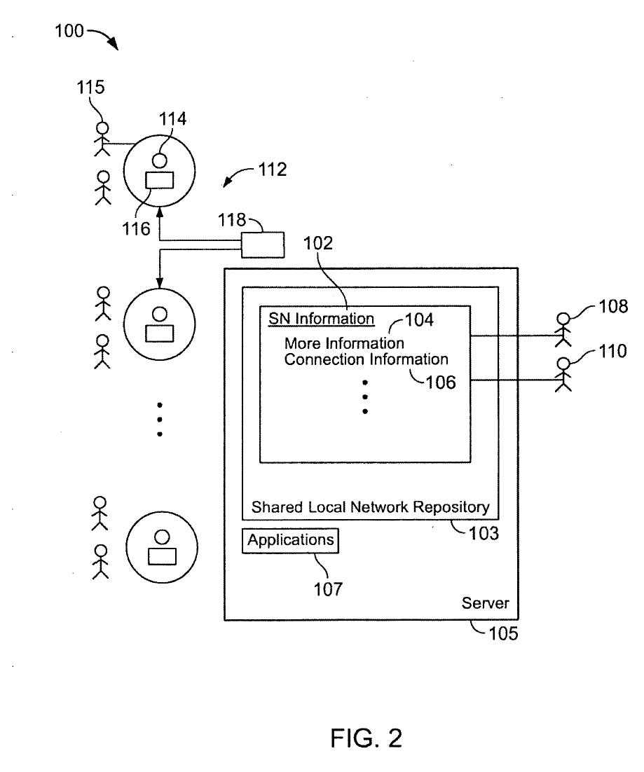

As shown in FIG. 2, a shared SN system 100 may, among other things, receive, create, aggregate, supplement, organize, maintain, use, make accessible, and distribute SN information 102 in a shared SN repository 103. The shared information includes, among other things, node information 104 and connection information 106 about users 108, 110. Users of the shared SN system 100 and users of a wide variety (and potentially a very large number) of other sites 112 (e.g., sites that have subscribed to services provided by or have otherwise become affiliates of the shared system 100) are able to submit, maintain, update, release, and provide permissions, authorizations, and other controls at a single shared SN repository.

Users of the shared SN system 100 and of sites 112 may then use proprietary or open features and applications that are running at each of the sites or combinations of them and that are designed to rely on and take advantage of the SN information of the users (and information about the users and others stored in the shared SN repository and at other sites 112 that have subscribed to or made other arrangements to use and/or contribute to all or part of the shared SN repository). The features and applications of the sites 112 may be ones that the users already use (for example, retail sites, portals, SN sites, and others), or ones that the users begin to use after having become users of the shared SN system 100.

We use the term sites extremely broadly to include any on-line or non-online capability, service, facility, resource, feature, or application that can make use of the SN information stored in the shared repository 103 in any way. Many examples of such sites operate using content of a wide variety of kinds. Sites include websites of all different types, including portals, commercial sites, individual sites, internal sites of enterprises, and all of the types of content that they support, including applications, audio, video, images, catalogs, and accounts to name a few. Sites may be relatively static or relatively dynamic, such as publications, blogs, review sites, photo, video, and audio sites, user-generated content sites, location information, mapping sites, and other kinds of content sites, among others. Static sites can be of the kind typically used for business to business marketing collateral and non-retail transactional sites (e.g., B2B transactions and client relationships that may not be naturally characterized as a “transaction”). Chat facilities, groups, instant messaging, emailing, and other forms of content based communication fit within the concept of sites.

In general, sites enable users to engage in activities, which we use in its broadest sense. Activities may include, for example, money-based transactions such as retail, wholesale, and business sales activities, investments, and financial instruments, and also non-money-based activities such as bartering, exchanging of information, registration, submission of content, borrowing, lending, and any other kind of exchange or passing of content or value from one party to another or among multiple parties, to name a few. Activities need not involve a bargain or exchange but could also involve, for example, an activity of a user with respect to content that may be available at the site. This could include submitting, updating, modifying, or removing content; searching, sorting, downloading, displaying, presenting, or retrieving content; participating in a group activity as an observer, a player, a critic, or a recipient; registering, signing in, accepting, withdrawing, or terminating rights, participation, membership, or accounts. These are only examples and the term activity is used in an extremely broad sense.

Sites may be present at any location, for example, on servers, on personal work stations, on portable devices, and at other places. Access to sites may occur through any communication channel, such as wired or wireless channels using any kind of communication infrastructure such as the Internet, intranets, dial up communication, dedicated and private networks and the like.

The repository 103 can be part of a server 105 hosted by a party that serves as a clearinghouse, broker, or medium for shared SN and other information derived from many sources and made available to many sites. The server may host a wide variety of other applications 107 that enable it to perform the services and functions described here, and many others. Access to the shared repository and the applications in the server can be made through any communication channel of any kind, including, in some implementations, networks such as the Internet.

The shared SN repository 103 can be created and maintained “once” without duplication of effort and then used by many sites (and users of the shared system and of other sites) in many ways and at many times. Because the users need only register (and provide other SN information) in one place to have their SN information available (with permission) at a large number of sites, they are freed from the need to register and maintain their node information and connection information redundantly at many different sites. This feature significantly increases the chances that users will participate in the shared system. Because users are more likely to participate, the system 100 substantially increases the opportunities for independent sites to create applications that take advantage of the information contained in the shared repository with a reasonable expectation of participation by a large number of users.

As the size, extent, complexity, and completeness of the shared SN system grows, its value to other sites and to users grows.

Other sites 112 that wish to use SN information are able to access, and make a wide variety of uses of the shared SN repository or portions of it, available at a single, convenient location reducing or eliminating the need for the site operator to convince its users to build their social networks within the site. The sites 112 can be completely flexible in how they use the shared SN repository information to best suit their business model and functions and the expectations of their users. Sites can combine all or part of the shared SN repository information with their own user information 114 (for example, SN information about their users 115, and non-SN information related to their users) for use by their applications 116. An application development toolkit 118 can be provided to the facilities to simplify their development and integration of such applications.

A variety of business models can be used to finance the shared system 100 and to generate revenue from it. In some models, in order to build the shared SN repository to a significant size quickly, the database and tool kit may be provided to affiliated sites at no charge or a small charge for an initial period of time to encourage those sites to adopt applications that will make use of the shared SN system. Later, a monthly or annual license fee may be charged to the affiliated sites for continued access. A wide variety of revenue models can be used to define the license fees, including licenses based on volume of use, number of transactions, revenue associated with the use, time-based charges, and others. Sometimes we refer to sites that are making use of information in the shared SN repository as affiliates or affiliated sites of the shared SN repository. Affiliates can include sites, other online devices, applications, features, and other entities and enterprises. Typically an affiliate has access to information in the shared SN repository by virtue of an agreement, license, course of dealing, or other authorization.

Other sources of revenue in some business models can include, for example, license fees from advertisers for uses of the shared SN repository, and development by the operator of the shared SN repository of applications that leverage the repository to generate advertising or usage revenues.

It also may be possible to derive other revenue streams from the users of the system 100, for example, by providing premium services associated with the use of the shared SN system or by enabling access by paying users to facilities that are otherwise restricted.

As indicated by the discussion above and as will be apparent from the following description, important features of the shared system include (but are not limited to) the following:

1. The system serves as a builder, clearinghouse, intermediary, and broker for information in the shared SN repository. Other sites (and other parties, including advertisers, manufacturers, distributors, and financial institutions, for example) can make use of the information in the shared repository as the basis of valuable and useful applications and features. Users of the shared system agree in advance to permit information about them that is in the shared repository (and, in some cases, would otherwise be considered confidential) to be communicated from the system to the other sites. The other sites, which are typically controlled independently from the shared system) control the sharing of that information, consistent with permissions given by the users to whom the information belongs, with people with whom the users are connected (according to the connection information in the shared repository). We sometimes refer to people with whom a user is connected simply as the user's connections. The display of the information about the users of the shared SN repository, to users of the other sites is done through the other sites. Each site can store some or all of the information from the shared repository in its own repository 116, combine it in any way it considers useful with its own information about its own users and other users, and decide how, when, where, in what manner, and under what conditions to display the information to its users. Arrangements are made between applications running on the shared system and applications running on the other sites to assure compliance with the permissions, and to facilitate a potentially large number and wide range of other features between the shared system and the affiliate sites.

2. Information associated with people with whom a user has connections, according, for example, to the shared SN repository, can be displayed by (or the user can be given access in other ways to the information by or from) a site in connection with a transaction or any other activity in which the user of that site is engaging. Thus, the display of the information about the user's connection is not triggered merely when the user specifically indicates an interest in the information about the connection, or users having similar characteristics, or based on selected types of connections (for example, “show me all of the people with whom I have connections and who graduated from the same college as I”). Rather the display (or other giving of access) can be determined on the basis of, in the context of, and at the time when the user is working on a transaction or other activity. For example, if the user has added red wool pants to his shopping cart on the Lands End site, then in conjunction with that proposed purchase, and without further action by the user, information about his connections that may relate to the purchase (for example, his friends who have also bought pants from Lands End) are displayed to the initiating user.

We use the term display to refer broadly to any way in which the information can be exposed or presented to the user (or by which the user may be given any kind of access), for example, by display on a computer monitor, but also on any other device, or by presentation of sounds, video, images, text, applications, or any other content or manner of providing it. Display can also refer to making the information accessible to a user for pickup at another location, for searching, or for downloading in any manner, to name a few examples. Any manner in which the user is aware of the progress or nature of a transaction or activity (in the broadest sense) may be a form of “display”.

3. A user of the system 100 can control the character and level of his relationship with his connections in a complex and finely grained way for later control of how the information about him is used and displayed to others. The user is not limited merely to indicating that he and the other person are “connected” or “not connected”. For example, a user may specify that he knows another user and the other user is therefore a connection, yet the first user can control the extent to which (for example, the time, place, context, frequency, conditions, purpose, and other parameters for which) his information in the shared repository may be displayed (or otherwise made accessible) to the other user. For example, the user could set a permission requirement for his confidential information that would require “ask me” permission on a particular site or other facility before his information could be provided to any of his connections.

Based on this flexible permission arrangement, a user may be able to see, in connection with his use of a facility, things he has in common with people to whom he has a connection, such as when he has purchased (or is considering purchasing) the same item, has traveled to the same place, knows the same people, or is located near the other person. The applications running on the site could include, for example, ones that enable a person to play games and have contests with people with whom he has things in common, enable users to share information about themselves with their connections while restricting access by others; allow communications between two users to be shared exclusively with their connections (for example, “shouts” and “walls” and “endorsements” . . . ); and be used to permit third parties (e.g., sites, businesses) that have user information that would otherwise be considered private to share that information with a user's connections.

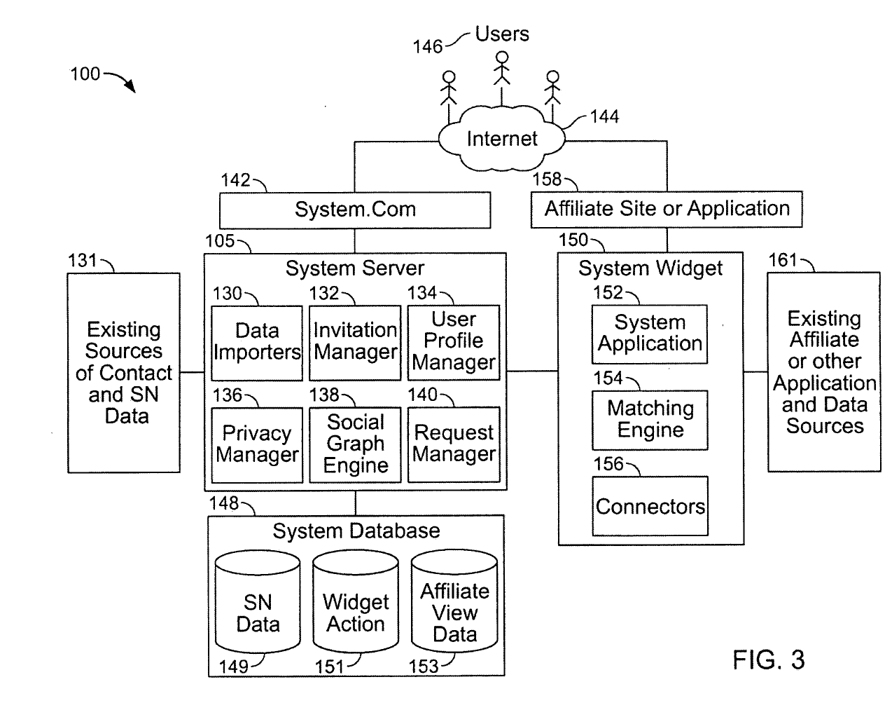

Another illustration of at least a portion of the shared system 100 is shown in FIG. 3. A system server 105 includes a number of functional modules. SN information importers 130 can import into the system environment SN information, including profile information, connection information, contacts and other information from a variety of sources 131, including the user's web mail accounts (e.g., Hotmail, Yahoo mail, Gmail, and others), a user's desktop mail system (e.g., Microsoft Outlook), SN sites where the user has an account (e.g., MySpace, Facebook, LinkedIn, and others), or other sources.

An invitation manager 132 keeps track of invitations to connect that a system member (we sometimes call a user who has registered with the shared system a member; we use the word “user” in a very broad sense not limited to a user who has registered, or a user who is a member) has extended to others and the invitations that are awaiting a response from the system member.

A user profile manager 134 keeps track of all attributes of a system member, including demographic information such as age, state and country, and gender, and identification information such as name, telephone number, and email address. A wide variety of attributes may be defined for this purpose and may include contact information, communication preferences, photos, various types of descriptors, and other information associated with a member.

A privacy preference manager 136 keeps track of the privacy (or authorization or permission) preferences that the user has expressed regarding other system members to whom he is connected or regarding use of his information by other sites and applications and features.

A social graph engine 138 tracks connections between system members and attributes that characterize those connections.

A report manager 140 generates reports from the information stored in the shared repository for audiences that may include system members, managers of affiliate sites and other sites, and system managers.

The services provided by the modules that run on the server are exposed through a System.Com site 142 that is accessible through the Internet 144 using a web browser located anywhere and permits users 146 to become members of the system, manage their system accounts, and manage the application functions that the system and its modules provide.

System members may choose to import their contacts, profiles, and SN connection information from other sites and applications where that information is already stored, such as the user's web mail accounts (e.g., Hotmail, Yahoo mail, Gmail, and others), the user's desktop mail system (e.g., Microsoft Outlook or others), SN sites where the user has an account (e.g., MySpace, Facebook, LinkedIn, and others), or other sources.

Shared SN system information is stored in, for example, a database 148. The information includes all information needed for the operation of the modules of the system server and other applications that may be added over time. The information includes, but is not limited to, connection information, profile information, user privacy and permission preferences, users' invitations to other users to connect with them (much of which can be stored in the SN data tables 149), log information on activities of the system server and applications (for example, when new members have joined, when connections between users have been made), log information 151 on the activity of the various system widgets (including display of system member names), and information about activities of system members 153 provided to the system by affiliate sites and applications.

The system widget 150 is application code that provides functionality to the affiliate sites using information and services provided by the system server and, in some cases, by the affiliate site or application or other sites or applications 161. The modules of the system widget include a system application 152 that exposes the functionality of the shared system to the user of the affiliate site or application or feature. The shared system can provide affiliates with application templates, which they may use in the form provided or may modify if required, to create applications. A matching engine 154 compares user IDs provided by the system server to user IDs provided by the affiliate application or site that is making use of the system application and returns matches to the system application, according to rules specified by the system application.

The system widget may provide connection facilities 156 to simplify the retrieval of information from the affiliate applications or sites from which information is to be obtained to support the functions of the system application. The affiliate site or application 158 is a site or application at which users may access the functionality of the system application (some functionality can be accessed by users directly through the System.com site).

The system widget may use information obtained from applications or sites of the affiliate or from other sources 161.

To take advantage of SN features on typical sites, each user must identify his SN connections by separate steps on each site. When the user signs up on another site, the user's SN connections must be re-identified to the new site. The repeated identification of SN connections can create a tangle of connections that sometimes may be incomplete or time consuming to re-identify.

Thus, considered at a higher level of abstraction, the shared SN system described here serves as an aggregation system for users' SN information, enabling them to maintain this information in a single place and to use features and applications that take advantage of the information at a large number of affiliate sites that subscribe to the shared SN system, including affiliate sites that the users already use.

An important feature of the shared system is the shared SN repository. This independent electronic database of SN relationships of a user can include the profiles of the system members, their connections to other system members, and their privacy (and permission) preferences with respect to their connections and to the affiliate sites. The database design can be structured to provide affiliate sites with the information they need to effectively tailor the social experiences they provide to the needs and expectations of their users while recognizing that different sites will need different types of information and also meeting the needs of system users for simplicity and speed.

### Shared System User Interface

As shown by way of one example in FIG. 4, the shared SN system can expose a simple, effective web-based user interface 200 through its own site to users. The interface provides the home page shown in FIG. 4 and pages for My Profile, My People, and Sites, accessible using buttons of a simple navigation bar 202. A series of status statements 204 reports on a variety aspects of the user's activities and connections and the status of the system. In some cases, links 206 enable the user to view more detailed information.

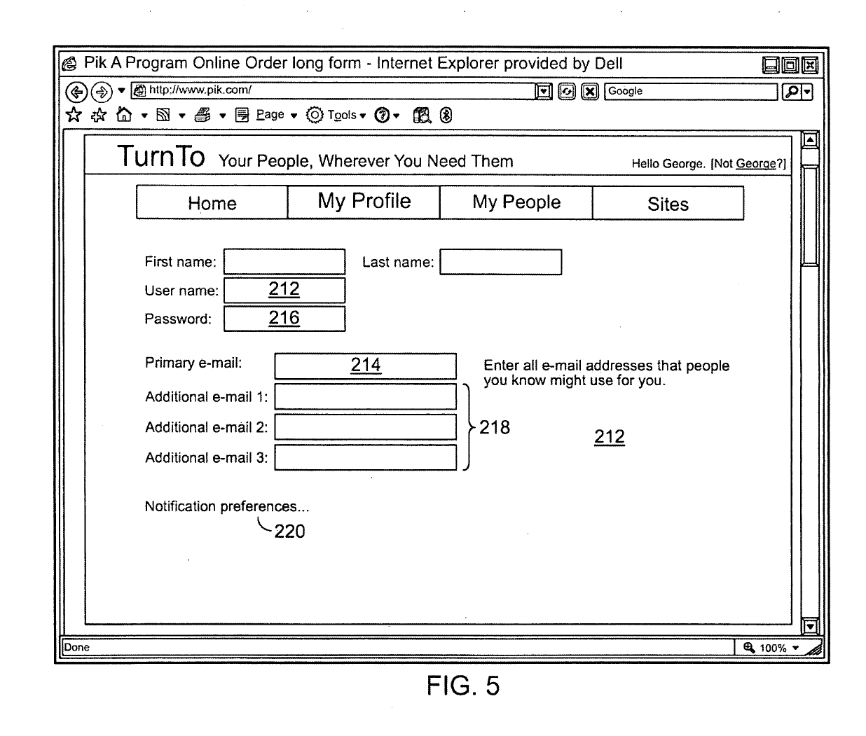

Clicking the My Profile button 208 of the navigation bar 202 invokes the page shown in FIG. 5. On this page, a new user can enter his profile for the first time or an existing user can alter his profile. Each member of the shared SN system can be identified within the system by a unique identifier, which may be a username 212, the user's email address 214, or another suitable ID mechanism. Access to all or part of a user's profile can be controlled by a password 216.

In addition, system users can provide all of the e-mail addresses 218 that might be used by their connections or by the affiliate sites to reach them. The user's email address can be used as a unique identifier that enables the system to cross reference user information stored on the shared SN repository with user information stored in the user records of affiliate sites. User e-mail addresses can also be used to import user connections from other sources. The system may require an e-mail confirmation step to validate that each e-mail address provided is legitimate. Other information about users may also be included in the profile, especially other types of contact information. In some implementations, the number and kinds of information that the user would be required to enter in his profile is kept small to enable a quicker sign-up and registration process, which may produce a higher volume of users. The user profile may also include information about the user's notification preferences, for example, whether the user wants to receive each notification in a separate e-mail or prefers the notifications to be bundled and delivered periodically.

### Two-Way Connections

A user can invite people he knows to be connections of his within the shared system. Each of the invitees may accept, decline, or ignore the invitation. If an invitee accepts, then a two-way connection is established between the users. In establishing this two-way connection, the user who extends the invitation and the user who accepts the invitation by doing so automatically are each deemed to have authorized (given permission to) affiliate sites that exist as of the time of the establishment of the connection and those affiliate sites that join later to share information that they may have or acquire about them, which might otherwise be considered private, with the other user in the connection. A system user agreement and privacy policies (and general explanatory text on the shared SN system site) can contain statements to this effect and other statements regarding the sharing of information. This permission model implemented by the system automatically enables an affiliate site to access and share the user's SN information from the system repository without requiring any further permission from the user SN.

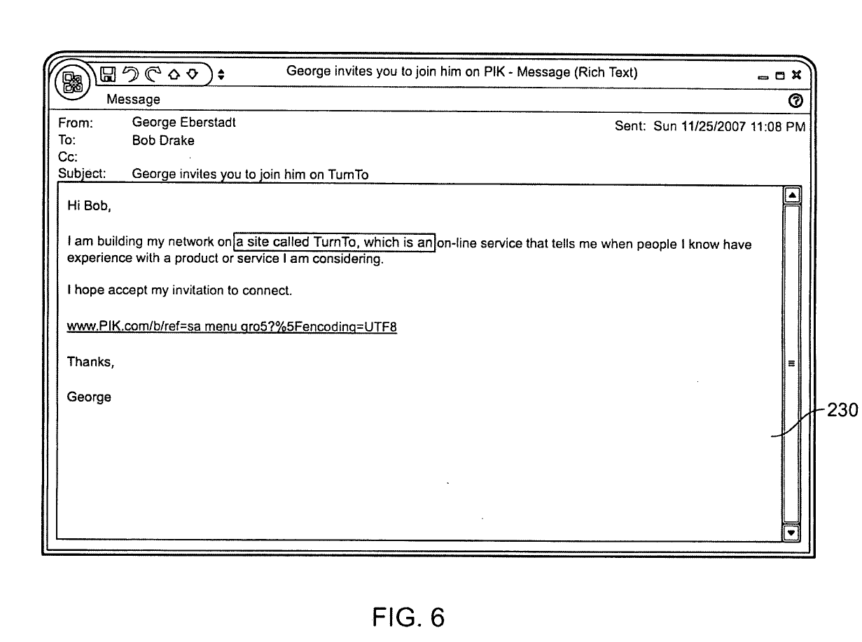

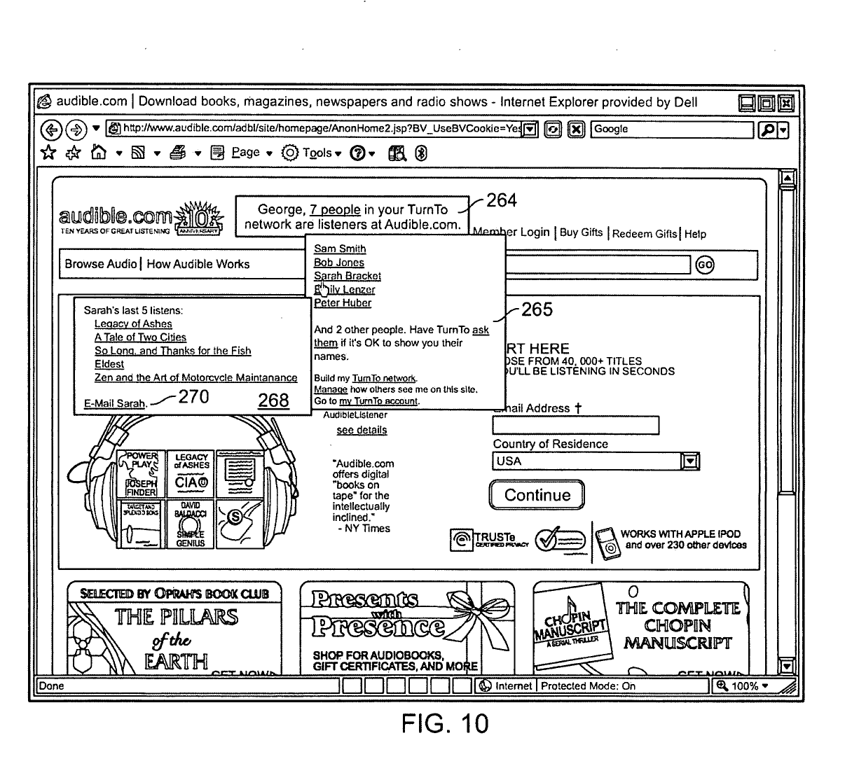

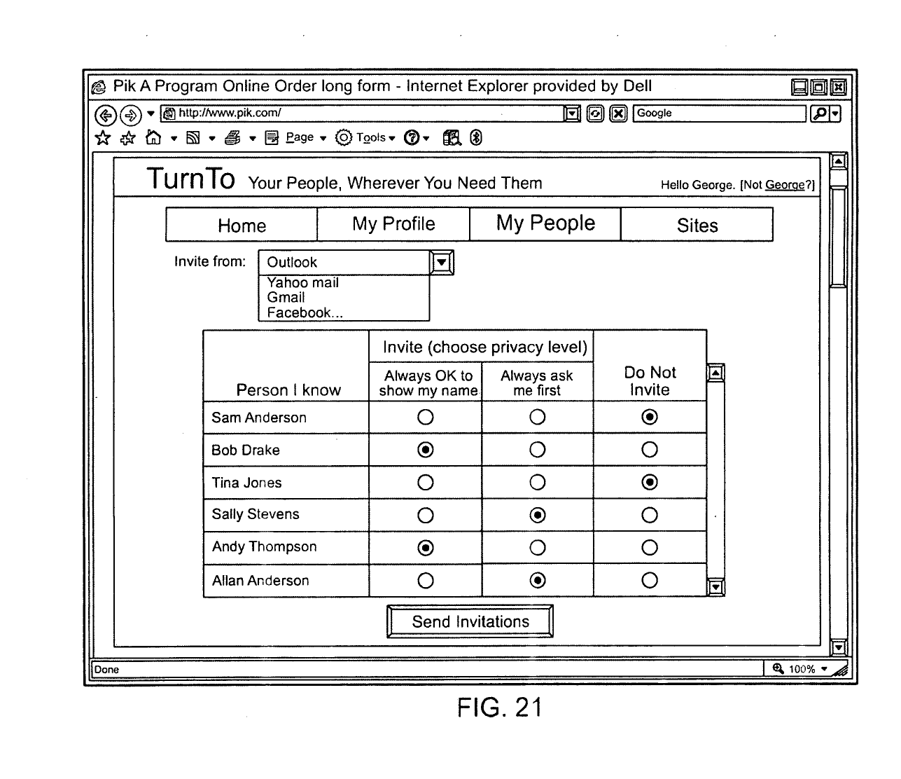

To specify a SN connection or create a connection within the system repository, a user can indicate (see FIG. 21) other people to whom invitations should be sent; the shared system then sends an invitation to the intended connection, generally as an e-mail, such as the e-mail 230 shown in FIG. 6 (in FIG. 10 and elsewhere, we sometimes refer to the shared SN system as the TurnTo™ system although a wide variety of other names could be used for trade purposes). (The user's knowledge of the invitee's e-mail address may be used as a mechanism to protect against invitation spam.) The e-mail of FIG. 6 may be generated automatically by the shared SN system based on information entered into a page to identify people the user wishes to invite.

In connection with the invitation process, the user can also set desired privacy preferences (e.g., permissions) for each invitee and add attributes or characteristics that describe the connection he intends to establish. If the invited connection is already also a system member, the connection need only accept the invitation and add his privacy preferences for the inviter and any connection attributes. On the other hand, if the connection is not yet a member of the system, the connection must both join the system and accept the invitation and add his privacy preferences for the inviter and any connection attributes. (The invitation e-mail can include information on becoming a system member.) The server of the shared SN system provides a user interface for extending (and accepting) these invitations and setting the privacy preferences and connection attributes.

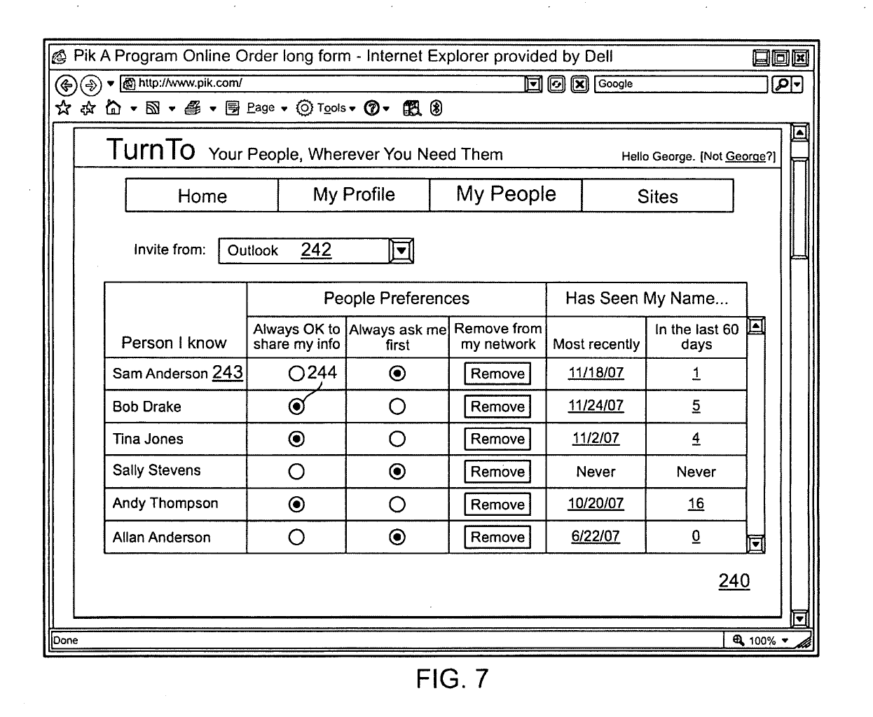

In one example of a tool to simplify the process of building a SN profile and connections within the system, as shown in FIG. 7, an example contact import screen 240 permits the user to select a contact management application such as Outlook in a box 242 and in that way to automatically send e-mail invitations to all of his Outlook contacts. Other techniques for easing the task of building a SN may include utilities for automatically exporting a user's contact list from web-based e-mail systems such as Yahoo, gmail, AOL, and others, and from a user's contact list and connection list from SN sites such as Facebook, MySpace, and LinkedIn.

Tools for performing these tasks can be arranged to enable the user to send multiple invitations and set multiple privacy preferences and connection attributes at the same time. In some implementations, a tool may present the list of all the contacts to be exported in a user interface (UI) that enables the user to easily designate, one by one, which contacts are to be invited, which are not, and which are to be deferred for later consideration. The user can set privacy preferences and connection attributes for each connection at the same time. The tool could enable the process to be rerun periodically to identify as new candidates any contacts that have been added to any of the source systems since the last export. Users could also designate contacts as persons of interest is (POS) with or without sending each of them an invitation to become a connection.

An invitation manager utility 132 in the shared SN system can be used to manage pending invitations. The invitation manager enables users to track invitations which have been extended but not yet accepted or declined and invitations they have received but not yet replied to. Invitations extended to people who are not yet system members can be held by the invitation manager until the person becomes a system member. In practice, it is possible for a person to accumulate many system connection invitations all of which will be presented upon the person becoming a system member. The invitation manager can match the e-mail address provided in the invitation to the e-mail address (or addresses) provided in the profile of the new system member.

### Ask-Me-First Preferences

A user of the shared system can control the manner, timing, and extent of his information that can be shared with any of his connections. In some implementations, a user can designate one of, for example, two or more levels of trust for each of his connections: a higher level of trust called, for example, “Trusted” or “Always Share,” and a lower level of trust called, for example, “Ask Me First”. An application or feature that uses the shared SN repository information may show a trusted connection a user's name, system profile information, and other information about the user held by a site, without consulting the user.

For example, in some implementations, an affiliate site for a resort can tell a user of the affiliate site (e.g., a prospective guest) if connections of his have stayed at the resort. The resort could provide the names (and perhaps the dates of the visit or other such information) of system members who have previously stayed at the resort and who have designated the prospective guest as trusted to that guest, without having to consult those system members.

In some implementations, an application or feature using the shared SN repository information may be prevented from showing a user's name, system profile information, and other information about the user held by the site to a connection designated as ask-me-first without first asking and obtaining permission from the user. In this case, the system provides a mechanism for requesting and logging that permission by e-mail or another method. In the case of the resort site, if some of the connections of the prospective guest have designated that person as ask-me-first, the application on the resort site must ask the connection for permission before sharing the connection's name or other information with the prospective guest. The request for permission could be done directly by the affiliate site or the affiliate site could request the system to make the request and confirm back to the affiliate site if the consent is obtained.

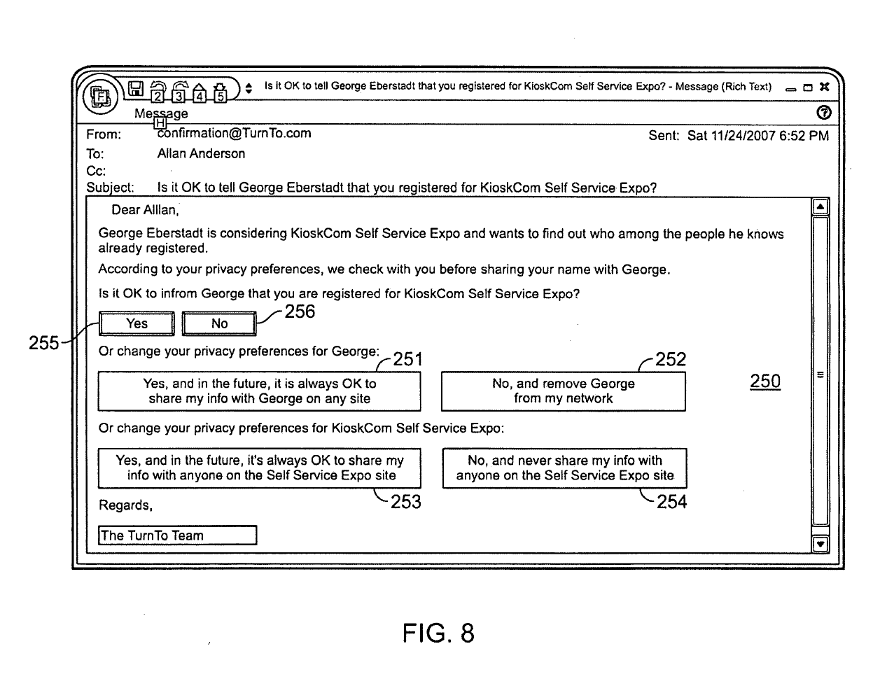

As illustrated in FIG. 8, if an e-mail 250 is used to ask a connection to accept or decline 255 or 256 a sharing of his information, an ask-me-first request could also provide opportunities for the connection to manage his general preferences with respect the user requesting the sharing or with respect to the site to which the request applies. For example, as shown in FIG. 8, the connection could be permitted, from within the e-mail 250, to switch his preferences for the user to trusted 251 or he could remove the user entirely from his connections 252. The connection could also, with the same e-mail, switch his preferences with respect to the site from, for example, requiring compliance with his connection-preferences to permitting site-wide trusting of everyone 253, or make-everyone-ask-me-first, or to opting out of the site entirely 254.

In the example of FIG. 7, a user of the shared system can indicate his privacy preferences (we sometimes use the term permissions to refer to preferences which include permissions, authorizations, consents, and other confirmatory actions) with respect to each of his connections 242. Radio buttons 244 can be used to switch between “always ok” to “ask me first” for each connection independently. A third column enables-the user to remove the connection from his network entirely. The final two columns provide for reporting when the connection most recently viewed the user's name on an affiliate site and how many times he viewed the name in the past 60 days. A wide variety of other preferences and reports could be provided for each connection or groups of connections.

### Site Level Preferences

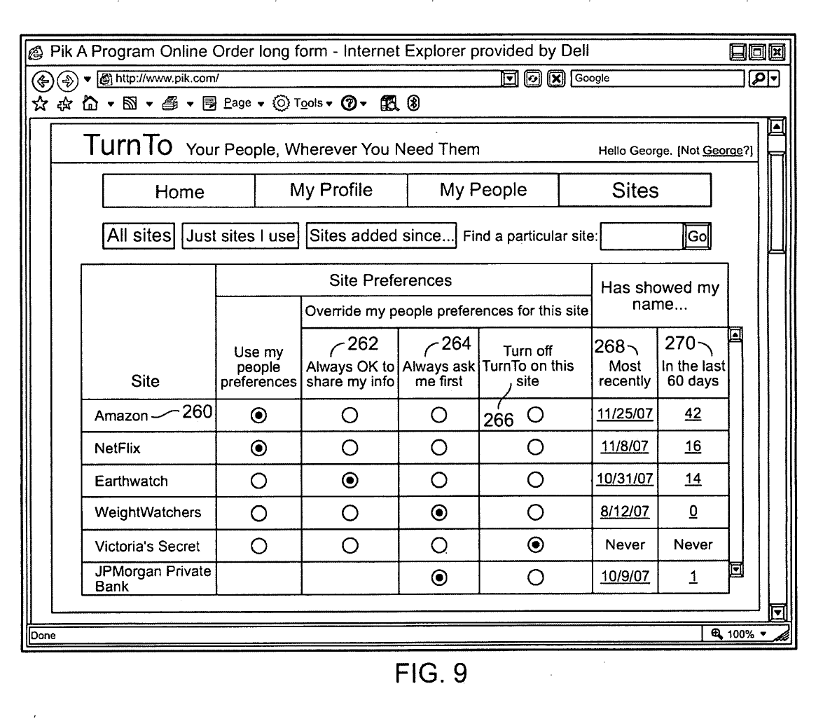

A user can over-ride a trust-level specified for individual connections (or more generally control the permissions to show his name and other information) on a site-by-site basis. For example, as shown in FIG. 9, on a page 258, a user may specify that at a given affiliate site 260, all connections are to be treated as trusted 262 or as ask-me-first 264, regardless of the trust-level otherwise specified by the user for each individual connection. A user can also opt out 266 of permitting his information to be shared with his connections, on a site-by-site basis.

At affiliate sites for which a user has opted-out, the user's name and other information will never be shared with the user's connections. In some implementations, in return for this privacy, the user will be denied the opportunity to see the names and information of his connections at that site (i.e., a user must be willing to share in order to have the information of others shared with him). The opt-out mechanism may be implemented with or without that behavior. Site-level preferences are recorded within the shared SN repository and govern the connection information that is provided to the affiliate site. For example, if a user has opted out at site X, the SN information provided to that site will exclude information about that user. The system user interface will enable users to browse a list of all the system affiliate sites or search for particular ones to simplify the process of expressing such site-wide preferences. The interface can provide a search for affiliate sites based on the date on which a site became an affiliate to enable users to more easily express site-wide preferences on sites which became affiliates after the user last reviewed the list.

### Other Attributes of a Connection

When a shared system user makes a connection, the system may provide the user with the ability to characterize the connection by certain attributes. For example, the user may specify that his relationship to the connection is a personal one, a professional one, or both. The user could also specify the context in which the connection was made in the real world, for example, at companies at which the users were colleagues or schools they attended together. This context information may be one-sided or require two-sided verification. For example, a user can specify that he knows a connection from having worked together at company X with no confirmation as to the truth of the statement required from the connection (i.e., one-sided), or that information may be held in an awaiting-validation state until the connection has confirmed it (i.e., two-sided). This relationship characterization information may be provided to affiliate sites to enable them to tailor their use of shared repository information. For example, a resort site could use only connections characterized as personal in showing a user which of his connections have stayed there, in order to remove the possibility of sharing such information with a business connection of the user.

### Multiple Networks

An alternative mechanism for enabling affiliate sites to tailor their use of repository information is for the shared repository connection information to be organized in multiple networks. Rather than tagging connections with attributes to differentiate them, the connections could be held in logically separate networks. For example, the system could manage one network for professional relationships and another for personal relationships. A connection between two users could exist within either or both. When a user invites another user to be his connection, the user could specify which networks the connection is being invited to join. Affiliate sites could subscribe only to networks that are relevant for their needs. As in the example above, a resort could subscribe to the personal system network, thereby limiting information sharing to personal connections of each user and excluding professional connections.

### One-Way Connections

Users may be permitted to designate connections that are one-way within the system, and are called “contacts” or “people of interest” (POI). (In this document, we use the word connection in a very broad sense to include, but not be limited to, one-way, or two-way or other particular types of connections.) No reciprocal confirmation of a relationship is required for the designation of a POI. A user need only have a way to identify the person within the shared repository. (A member-search function may be provided for that purpose.) The designation of a POI does not entitle the user to access any private information about the POI within the system or at affiliate sites, but it would enable affiliate sites to bring public information about the POI to the attention of the user. For example, at a photo sharing site, photos posted by a POI for public viewing may be highlighted for the attention of a user (useful in a sea of public photos). Private photos would only be shared in accordance with a two-way connection between the users.

Users can establish groups within the shared system repository. A group could establish the same permissions that two-way connections provide (and others as well) but the permissions would apply to all connections among members in the group. The creation of a group would save members from having to establish separate two-way connections between each pair of members of the group and to maintain those connections as members enter and leave the group. (In effect, a connection is a special case of a group having two members.) Privileges would be designated for certain members of the group to manage membership in the group and the ways in which affiliate sites could employ the group connections. A group would be useful in a case, for example, where there is a large but often-changing network of connections that would be desired for use on multiple affiliate sites. For example, a club of book-lovers might establish a group of all its members (a list that changes frequently) that would be used by multiple book-selling and book enthusiast affiliate sites to facilitate interactions among the club's members at each site. We use the term group in a broad sense to include, but not be limited to, the example explained above, contact lists in contact managers, and other ways to identify sets of people.

Use of Existing Connection Information from SN Sites

For a SN site that enables third-party applications to access the site's SN information, for example Facebook and LinkedIn, it may be possible to build an application that would continuously import complete connections to the shared SN system as they are formed within the SN site. The connections could be imported directly from facilities that deliberately expose them to third parties, or could be scraped from the Internet by other techniques, or could be acquired in other ways.

For example, in some implementations, Facebook user A could install a Facebook application for the shared SN system and automatically become a member of shared SN system. Facebook user B, who is a connection of user A within Facebook, could install the Facebook application and also automatically become a member of the shared SN system. Facebook user B would also have a connection with A within the shared SN system because of the connection within Facebook. Facebook user C, who is a connection of both A and B within Facebook, could install the Facebook application and automatically become a member of the shared SN system and a connection of both A and B within that system.

In some implementations, the shared SN system can be structured to adopt future technology and standards supporting SN portability. For example, Google™ recently announced a set of standards defining how applications can access SN information, called OpenSocial. The shared SN system could adopt OpenSocial as the means for shared SN system-enabled applications to access shared SN repository information.

### Use of the System by Affiliate Sites

To promote adoption of the system by third party affiliate sites, the system provides general purpose applications that make use of the system repository and can easily be incorporated by many potential affiliates in their own sites. One such application, which would be significant in the realm of online commerce, for example, is the “Trusted Reference” application.

### The “Trusted Reference” Application

As illustrated by example in FIG. 10 with respect to Audible.com®, in the Trusted Reference application, a prospective user of an affiliate site who is also a member of the shared system, upon coming to the affiliate site, is greeted with a message 264 of the form “Hi <username>. <number> people in your system network <have done whatever the user is contemplating doing>.” In another example, at an electronics shopping site where the user is considering purchase of a camera, the message might say, “Hi Bob, 4 people in your network have bought cameras at <this site> in the last 6 months.”

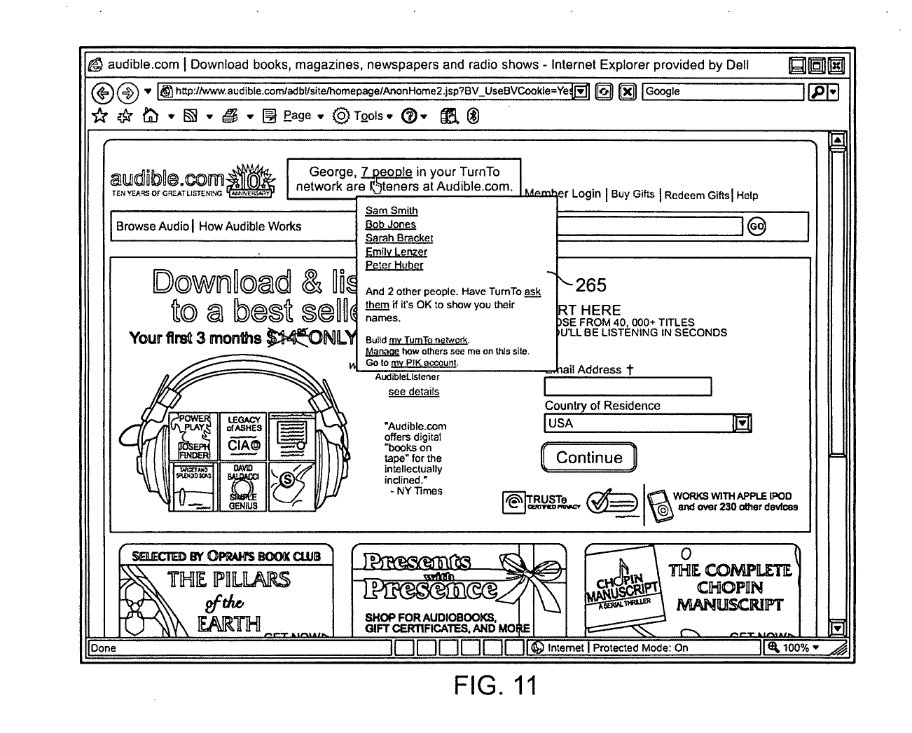

By clicking on the link in this message, the user is shown the names 265 (FIG. 11), of all (or some subset of) connections who have designated him as trusted and is given the chance to request the system to ask any users who have designated him as ask-me-first whether they will permit their name and information to be shown to the user in this context. If ask-me-first connections give permission, the user is alerted (according to the user's notification preferences) and that connection's name then appears along with those who have designated the user as trusted.

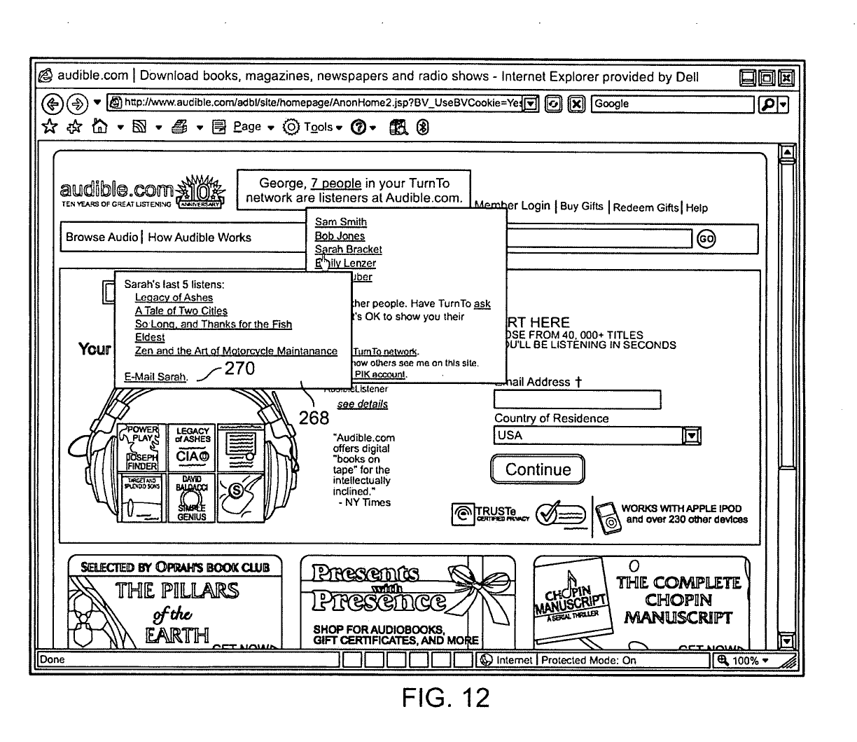

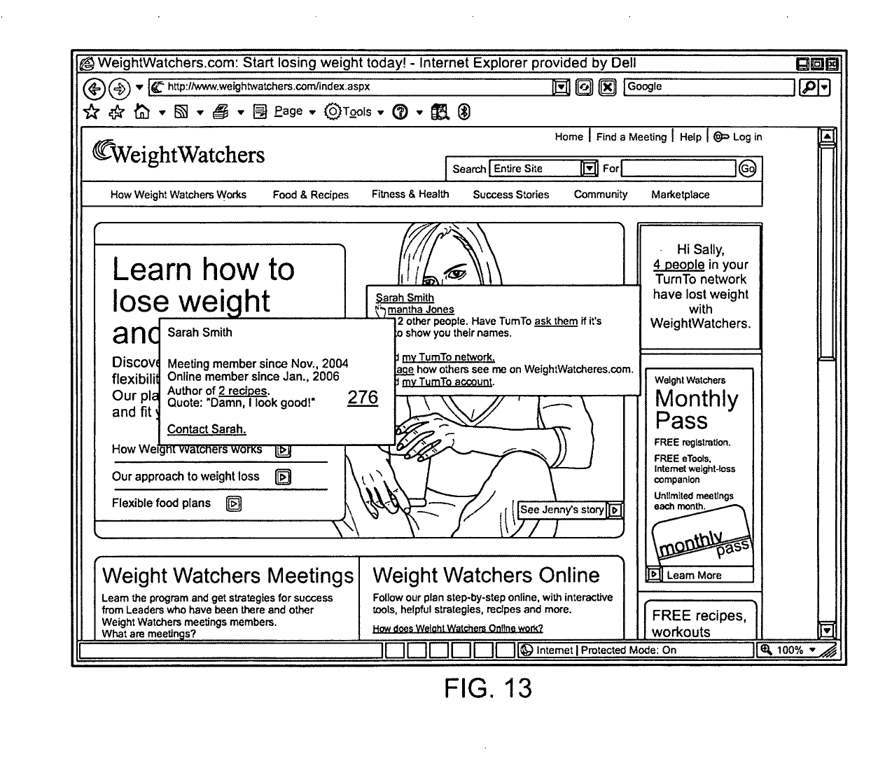

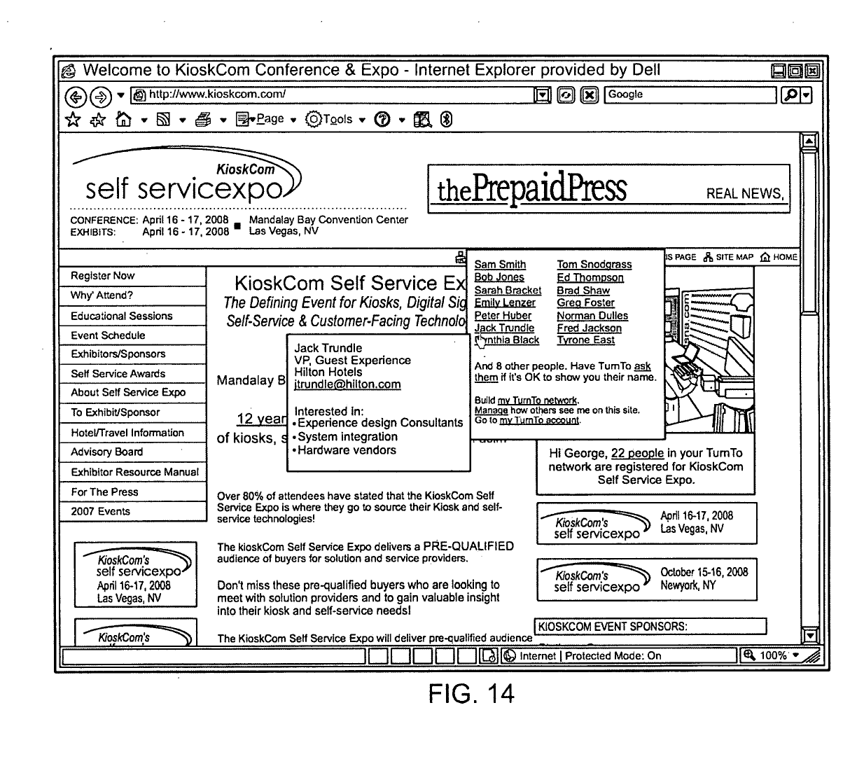

The affiliate site's application may be configured to enable additional information about each connection to be shown. In the example above, in response to the user clicking on a connection's name, the application could show which camera that connection bought at that site. Another example of additional information that can be displayed is information 274 in FIG. 13, with respect to an illustration using the WeightWatchers® site as the affiliate. In the example shown in FIG. 12, the last five listens 268 on the Audible.com affiliate site are shown to the shared system member. A link 270 enables the user to immediately send an e-mail to the connection. Alternatively, the affiliate site might show all products that the connection has bought at that site within some period. Or it could show any product reviews that have been written by that connection at that site. Yet other examples of information that can be displayed are shown in FIGS. 14, 22, and 23.

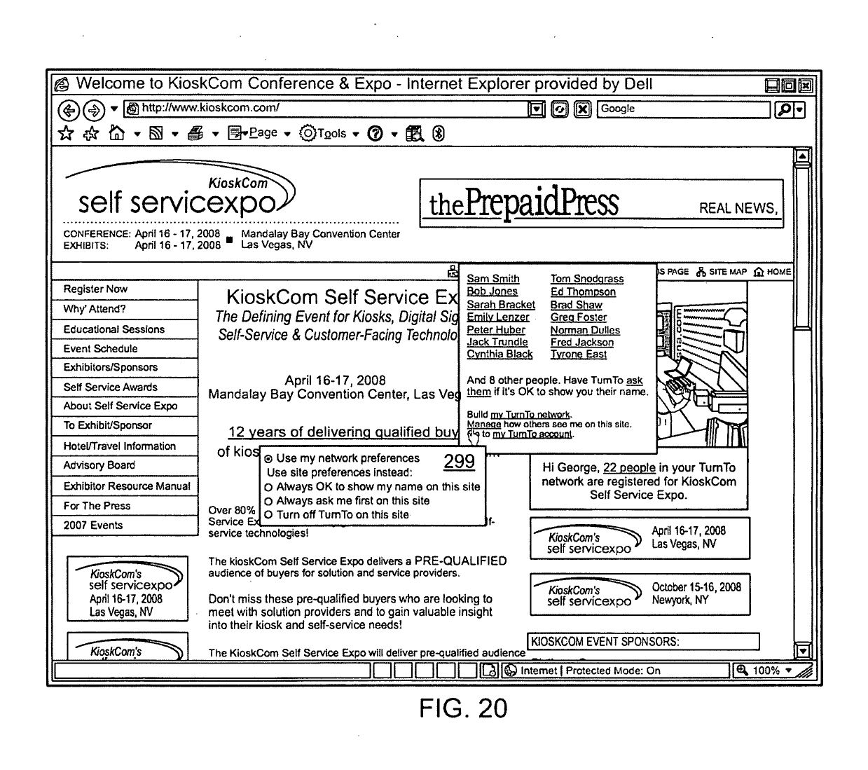

In some applications, for example, as shown in FIG. 20, when a user clicks on a link indicating a desire to manage his permissions, a box 299 opens to enable him to adjust his preferences.

In some possible implementations, when a user is considering an action or engaging in an activity (e.g., buying a camera, joining an association, going to a resort, attending a conference, or hiring a vendor), the application could share trusted references with the user at just the moment (or at a time related to) when the user is considering the action. While users will sometimes know some of their connections to whom they can turn for advice on particular topics, they will often not be aware of everyone in their network who has relevant experience, and so may miss the chance to consult. The trusted reference application makes it more likely that the people with relevant experience can be located.

The Trusted Reference application works by finding names that appear in common in a list of the user's connections, provided from the shared SN repository, and a list of users provided from the affiliate site's repository. In building and using its applications, the affiliate site has the flexibility to filter the list of names from the shared SN repository for the comparison in any way it chooses. By way of a few examples, connections could be filtered based on all shoppers at the affiliate site, only those who have purchased cameras and only in the last six months, only those who have agreed to be references or who have high customer satisfaction scores, or only users who have been members longer than 3 years, and in a wide variety of other ways. In addition, the affiliate site's application could combine several of the filtering criteria. Once the list of trusted connections has been generated, the application can, if it is configured to do so, obtain additional information about those connections from the affiliate site repository to share with the user. The Trusted Reference application identifies the user by cross-referencing his unique ID used to access the affiliate site. The Trusted Reference application can query a browser cookie set by the affiliate site to identify the user. When user information is not stored in a browser cookie, the shared SN system can set its own cookie to identify the user. This enables the application to show a user his trusted reference list even if the user does not yet have an ID with the site.

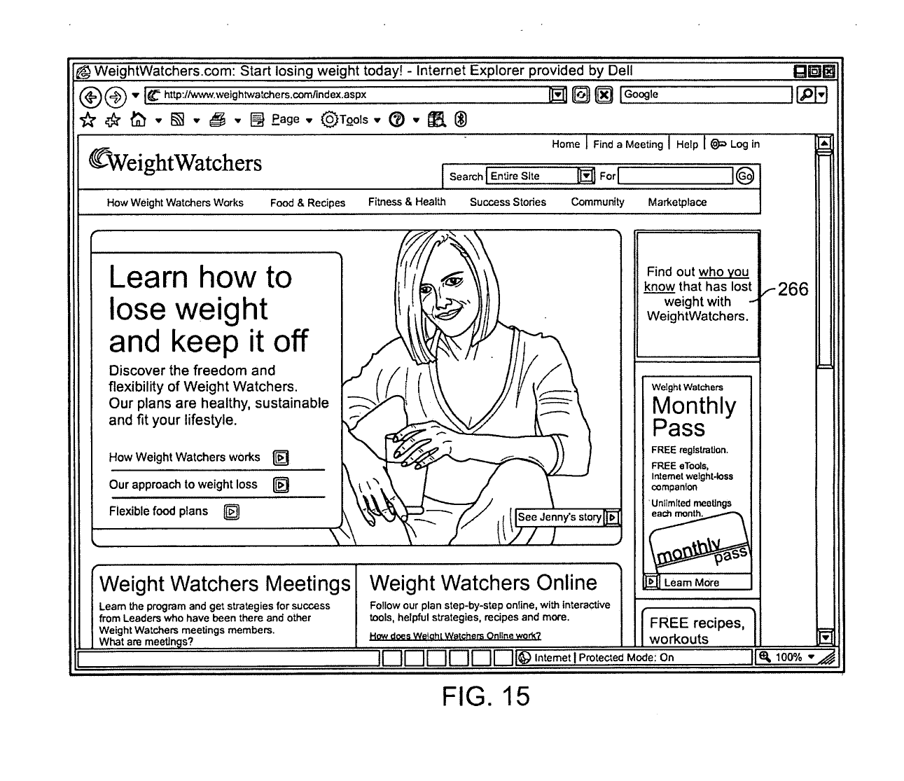

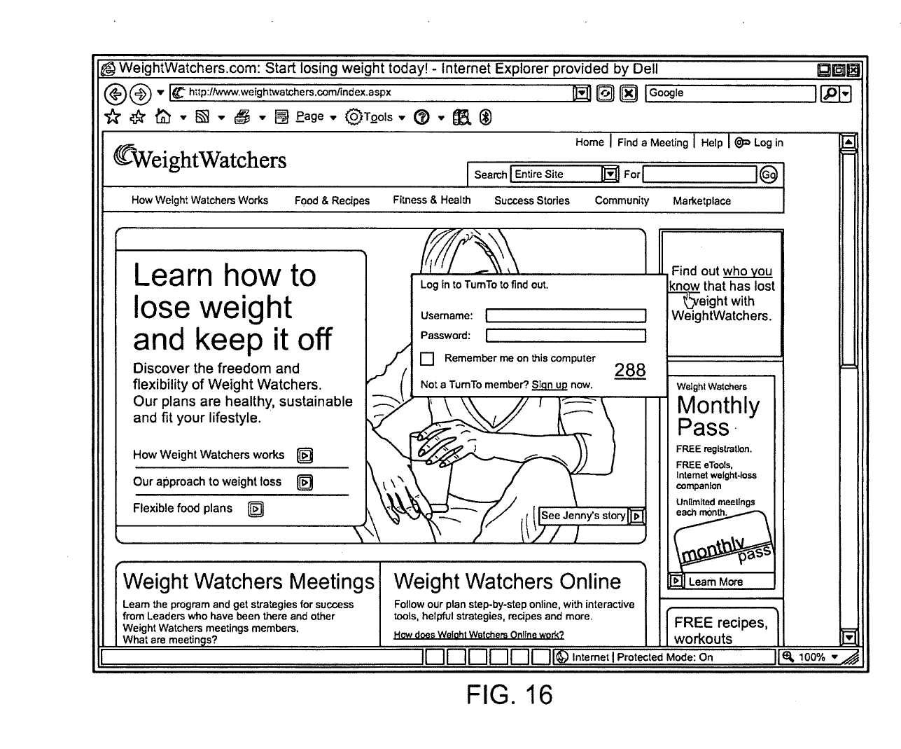

If a user who is not yet a shared system member enters an affiliate site employing the Trusted Reference application, the user will see a message such as, “Find out who you know that <has done whatever the user is contemplating>.” (This is illustrated for WeightWatchers® as message 266 on FIG. 15.) Clicking on the link in this message will open a dialog box 288, FIG. 16, that asks the user to log in if already a shared system member (in case the system lost the cookie identifying the user), or inviting the user to become a system member if not already one. If the user clicks on the invitation message, he is led through the enrollment process. This feature allows each affiliate site to be used as a recruiting point for members for the shared system.

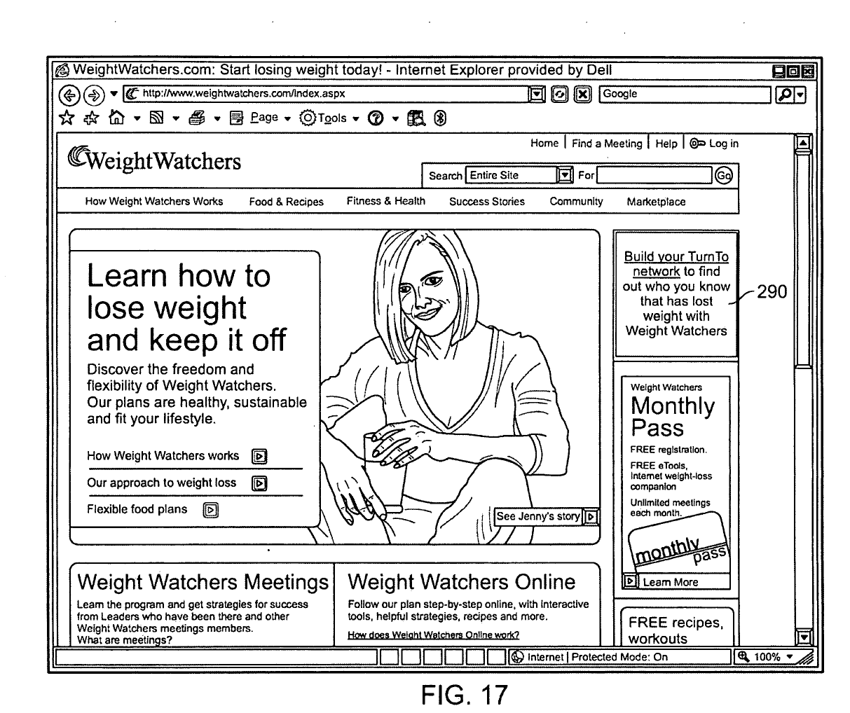

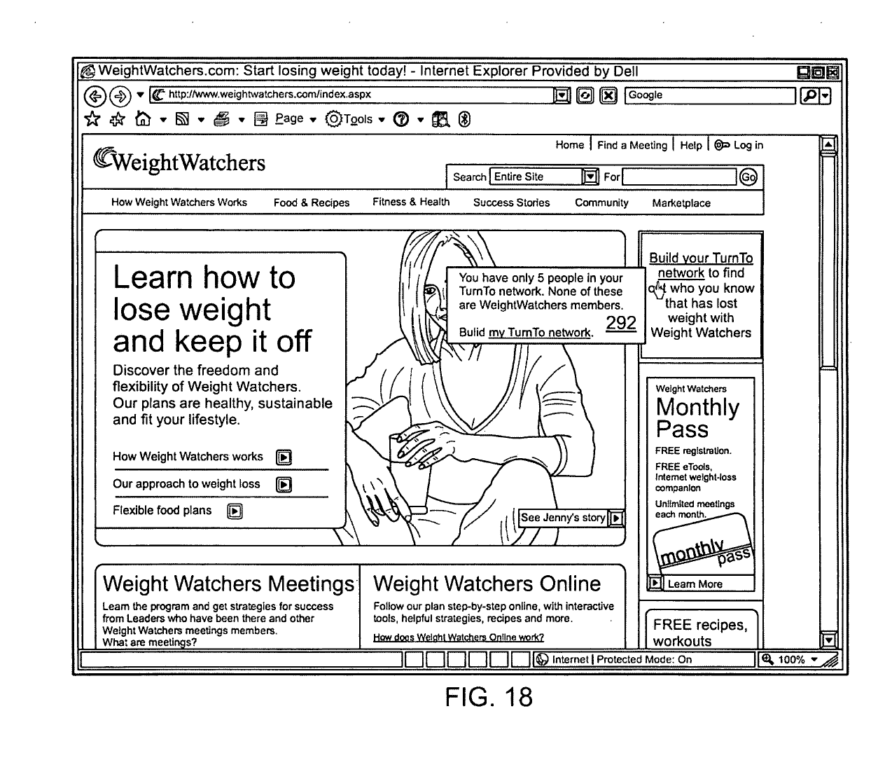

If the application recognizes the user as a shared system member but identifies no trusted references of the user, the application can determine whether the user has a number of connections in the shared system repository that is larger or smaller than a threshold amount (which can be set by the affiliate site). If the user's network is smaller than the threshold, a message can be displayed to the user, for example, “Build your system network to find out who you know that <has experience with whatever the user is considering doing>” as illustrated in FIG. 17, message 290. Clicking on the link could call up a dialog include a message such as, “You have only <number>people in your system network. None of these <has experience with whatever the user is considering doing>. Click here to build your system network” (for example, message 292, FIG. 18). If the size of the user's network is larger than the threshold, then the application could be set to display no additional message. An affiliate site can set the threshold level based on whether it is eager to encourage users to grow their shared system connections or concerned about troubling users with too many reminders.

### Other Applications

As affiliate sites gain experience with the use of the shared SN system and repository, the range of applications employing repository information may grow. The shared system can provide tools to simplify the creation of these applications and provide services to support affiliates in creating system-enabled applications. A very broad range of applications and features can be developed. A few illustrative examples include the following. The display of content created by a user's connections or POIs can be prioritized (e.g.. reviews, blog entries, and photo postings). Alerts can be triggered when connections are physically near each other. Quizzes, games, and contests can be established between connections. Trusted references can be provided on prospective employees and trusted references can be provided for applicants on the companies they are considering joining. User profiles can be compared to identify things that connections have in common and areas of differences. Connections can be automatically alerted when users achieve certain milestones or when a trigger event occurs.

### Contextual Preference, Network and Account Management

Dialog boxes may contain other links, including an invitation to the user to add to his shared system connections, a link to his system account on the shared system site, a link to a page describing the affiliate site's policies for use of shared repository information, and a link to a dialog that enables the user to manage his site privacy preferences (some of these features are illustrated in message 265 of FIG. 21). This last dialog could provide options for the user to over-ride the trusted/ask-me-first preferences for individual connections with site-wide preferences such as trust-all-my-connections-on-this-site, treat-all-my-connections-as-ask-me-first-on-this-site, and opt-me-out-of-this-site.

### Policies

The interests of an affiliate site and its users are generally aligned in that the site wants to provide value to its users and does not want to embarrass or alienate them by sharing private information in ways those users would not want. Because the means for achieving these ends may differ from site to site, the shared SN system is designed to allow affiliate sites flexibility in how they use the repository information. A first recourse for a user who is unhappy with an affiliate site's use of information about the user that it has acquired from the shared repository could be to set his site-wide preferences for that site to “ask-me-first” or to opt out of system functions on that site entirely. The shared system can establish guidelines of acceptable use that affiliate sites will be required to follow. The shared system may refuse to allow sites that won't comply to become affiliates or to shut off affiliate sites that violate the policies. To further aid dispute resolution, the shared system can enable users to report abuse or misuse by affiliate sites.

For affiliate sites to provide privacy behaviors for shared system-enabled applications that are appropriate to their businesses, affiliate sites will be able to use the shared repository information in a more restrictive way than that required by the terms of use and privacy agreement that the shared system has with its members or that the shared system members themselves have specified. For example, a site may itself choose to use only a shared system personal network and not a shared system professional network (if the system employs a multiple-network model), or it may choose to use only connections flagged as personal and not those flagged as professional (if the system employs the connection attribute model). Also, a site could specify that all connections are treated as ask-me-first regardless of the users' connection settings to provide all users with the opportunity to decline every instance of information sharing.

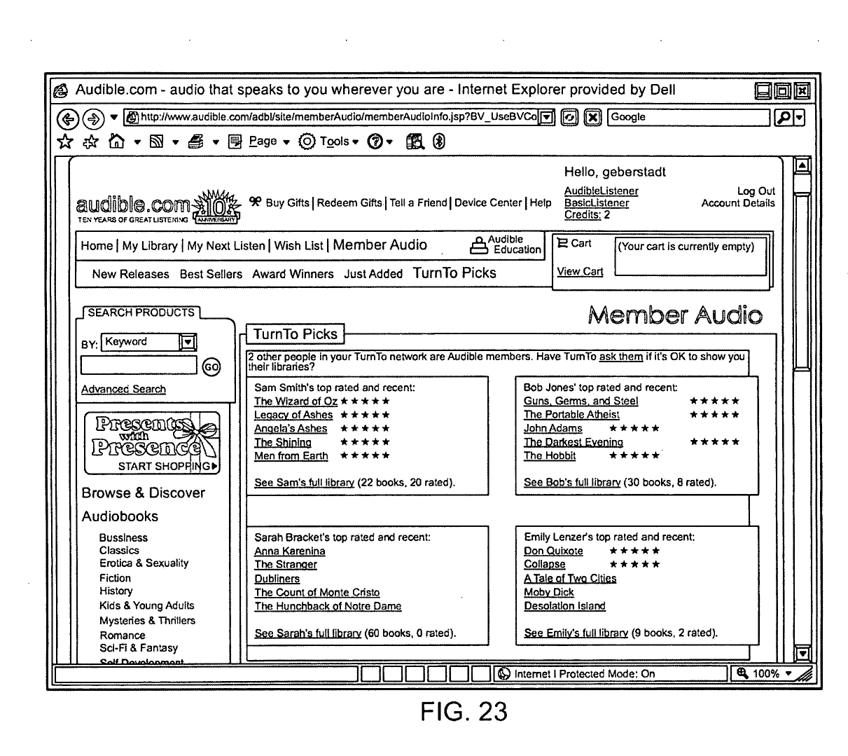

The message 280 on FIG. 23 is an illustrative example of an affiliate site for a private banking service that would not share connection information without first asking the connection.

Integration with Affiliate Site Information

To aid an affiliate site to build a shared system-enabled application, the shared system may provide tools to simplify the integration of the system-enabled application with existing user and customer records. For example in one implementation, an App Exchange application program is provided for the Salesforce.com site. This application enables sites and businesses that have user and customer information in the Salesforce.com system to easily specify which records and which information elements are to be provided to the shared system application. Other similar connectors can be built for other common repositories of user and transaction information.

### Registration of Affiliate Sites

In some implementations, each affiliate site is registered with the shared system and can be listed with corresponding applications within the shared system. The shared system user interface would enable users to express site-wide preferences for all affiliate sites from a single location. (If a single site uses of information from the shared repository for more than one application, the individual applications may be registered separately.) The affiliate sites will provide descriptions of the functionality of the applications as part of the process of registering a shared system application and this description will be available at the shared system site.

Passing of Information from Affiliate Sites to the Shared System

The shared system enables applications to function without requiring affiliate sites to share any information they maintain on their users and their users' activities with the shared system. In some cases, the freedom to use the shared repository information without sharing site specific user information with the shared system may be an advantage to affiliate sites. However, in some implementations, the shared system may also acquire information from the affiliate sites.

The applications may send to the shared repository logs of when, in what context, and by whom information on each shared system user was viewed. This information can be used to provide reports to users regarding the visibility of their names. It can also be used to provide reports to affiliate sites on the use of their applications. And it can be used by the shared system itself to evaluate use of the system.

In some implementations, applications may also send back to the shared system profile or activity information from the affiliate sites on system members. This information may be aggregated to enable analyses, reports, and applications that span affiliate sites. For example, a shared system user may buy books from multiple affiliate sites. By aggregating such purchase information for the shared system member across all affiliate sites, connections of that user could more easily discover whether that user had bought a particular book on any of those sites. Such analyses could be made available to users at the shared system site, or the aggregated information could be provided back to the affiliate sites to power multi-affiliate applications that run within the affiliate sites.

Other implementations are within the scope of the following claims.

Among other applications, the shared system could be used in connection with recruiting (to find people who know the candidate), job searching (to find current employees who have information), attendance at conferences (to find people who are planning to attend), reading (to find people who have read an item, or to find items authored by people you know), podcast listening (to find other people who have listened), association membership (to find people who are already members), game competition (to find people who are already using the game), instant messaging or online emailing (to find people who are available to communicate), or location seeking (to find people who are physically near to you). Any application in which users wish to know about activities of people with whom they are connected, and also to be able to control the access of others to information about their own activities would be a potentially good application for the shared system. More generally, the shared system would support applications in which users can maintain connections with people they know, learn about the activities of those people in a wide range of contexts, and be able to constrain the release of their own information to individuals, groups, or users of a site or other facility.

For example, the affiliate may include a site, mobile application, client-server program, or any program that interacts with other users through, e.g., an online connection.

Possible applications include commerce recommendations, employment references, conference registration support, discussion of particular articles, other recommendations, associations, games, and location references.

In some examples, the shared system could build and offer members its own applications running within the system online service environment. The shared system could enable third-party applications, including those from affiliate sites, to run within the shared system environment.

1. A method comprising
providing, to a user of a site, access to information about a person to whom the user has a connection, which is stored in a shared social network (SN) system controlled independently of the site, the information being displayed to the user of the site only in accordance with a permission of the person to whom the user has the connection.

2. The method of claim 1 in which the site comprises an affiliate of the shared SN system.

3. The method of claim 1 in which the information about the person comprises personal information.

4. The method of claim 1 in which the information about the person is relevant to an activity being engaged in by the user of the site.

5. The method of claim 1 in which the information about the person comprises information about an activity of the person that is relevant to an activity being engaged in by the user of the site.

6. The method of claim 1 in which the permission is stored in the shared SN system.

7. The method of claim 1 in which providing the information includes displaying the information.

8. The method of claim 1 in which the site provides the information in connection with a feature or application of the site.

9. The method of claim 1 in which the feature or application enables the user to engage in at least one of: a transaction, interaction with content, or a game.

10. The method of claim 1 in which at least some of the information about the person is retrieved from storage in the site.

11. The method of claim 1 in which at least some of the information about the person is retrieved from storage at the shared SN system.

12. A method comprising
maintaining a shared SN system that includes information about a connection that a person has with a user of a site that is controlled independently of the shared SN system, the shared SN system also including information about a permission given by the person to permit access by the user of the site to information about the person, and
making the connection information and permission information available to the site.

13. A method comprising
at a shared SN system, maintaining SN connection information that has been entered by users through multiple sites that are controlled independently of the shared SN system and independently of one another.

14. The method of claim 13 in which the connection information for a user of the shared SN system includes a permission given by the user to permit one or more of the sites to allow access by a person who has a connection to the user, to information of the user.

15. The method of claim 13 in which the SN connection information is shared with one or more of the sites under predetermined conditions.

16. A method comprising
in conjunction with displaying information to a user of a site about an activity of the user, also displaying additional information that relates to the activity and is about a person with whom the user has a connection, which is stored in an independently controlled shared SN system.

17. A method comprising
enabling a user, who has confirmed the existence a connection with another person as stored in a shared SN system, to regulate access to information about the user by the person to whom the user has confirmed the existence of the connection.

18. The method of claim 17 in which the access is regulated based on a category to which the other person belongs.

19. The method of claim 17 in which the access is regulated based on the identity of the other person.

20. The method of claim 17 in which the access is regulated based on a feature of an activity of the other person on a site that is controlled independently of the shared SN system.

21. A method comprising
at a site, providing a first user access to information about another person who is also a user of the site and who has a connection to the first user, the connection being evidenced by information stored on a shared SN system, the access being given in accordance with a permission of the other person.

22. A method comprising
at a shared SN system, storing connection information and permission information about a user, and
at multiple sites that are controlled independently of the shared SN system, providing features and applications that are based on the stored connection information and permission information and on information about the user stored at the sites.

23. A method comprising
at a shared SN system, storing a permission of a user to be applied at an independently controlled site to regulate access to information of the user stored on the site.

24. The method of claim 23 in which the permission is inferred automatically when the user registers on the shared SN system.

25. The method of claim 23 in which the permission is associated with a specific person.

26. The method of claim 23 in which the permission is associated:with the site.

27. The method of claim 23 in which the permission comprises a trusted permission that enables the site always to give access to information of the user.

28. The method of claim 23 in which the permission comprises an ask me first permission that enables the site to give access to information of the user only after obtaining explicit permission of the user.

29. The method of claim 23 in which the permission is associated with a characteristic of a connection between the user and another person.

30. The method of claim 23 in which the connection information is organized in multiple networks based on characteristics of the users.

31. A method comprising
at a site, regulating access by a user to information about another person with whom the user has a connection, which is stored in an independently controlled shared SN repository, the access being regulated based on a characteristic of the connection.

32. The method of claim 31 in which the connection comprises a one-way connection.

33. The method of claim 31 in which the characteristic comprises the user of the site being a person of interest of the other person.

34. The method of claim 31 in which the characteristic comprises the user of the site having been invited to be a connection of the other person.

35. The method of claim 31 in which the characteristic comprises membership by the user and the other person in a group.

36. A method comprising
at a shared SN system that is accessible from multiple other sites, automatically importing SN connection information from an SN site that has connection information that is exposed to or can be gathered for use by third parties, to build an SN connection repository at the shared SN system.

37. A method comprising
advising a user, who is engaged in an activity on a site, that by registering with a shared SN system he may obtain information that is related to the activity and is about people with whom he may have connections, and
by a feature of the site, enabling the user to register with the shared SN system.

38. A method comprising
providing SN information from a shared SN system to an independently controlled site for use in a feature or application that serves users of the site, and
refraining from requiring any information to be returned by the site to the shared SN system.

39. A method comprising
at a shared SN system, maintaining SN connection information about a user of the system, the connection information including a permission given by the user to permit one or more sites that are controlled independently of the shared SN system to allow access by a person who has a connection to the user, to information of the user that has been generated based on activities of the user on one or more of the sites.

40. A method comprising
at one or more sites that are controlled independently of a shared SN system, allowing access, by a person who has a connection to a user of the shared SN system, to information of the user that has been generated based on activities of the user on one or more of the sites, the access being allowed based on a permission that has been given by the user and has been recorded on the shared SN system.

41. A method comprising
enabling a user at a site to register connection information and permission information on a shared SN system that is controlled independently of the site, and
enabling the user to take advantage of the registered information in connection with using another site.
